(19) United States
(12) Patent Application Publication
(10) Pub. No.: US 2026/0355790 A1
(43) Pub. Date: Nov. 12, 2026

(54) Seasoning Feeding Apparatus, Seasoning Feeding Pipeline Cleaning Apparatus and Cleaning Control Method Thereof, and Cooking Device

(71) Applicant: SHENZHEN BOTINKIT CO., LTD., Shenzhen, Guangdong (CN)

(72) Inventors: Fuzhuang LIU, Shenzhen, Guangdong (CN); Guo CHEN, Shenzhen, Guangdong (CN); Minggui YAN, Shenzhen, Guangdong (CN)

(73) Assignee: SHENZHEN BOTINKIT CO., LTD., Shenzhen, Guangdong (CN)

(21) Appl. No.: 18/997,050

(22) PCT Filed: Jun. 4, 2024
(86) PCT No.: PCT/CN2024/097379

§ 371 Date: Jan. 18, 2025

(30) Foreign Application Priority Data
Sep. 20, 2023 (CN) 202311217995.2

(51) Int. Cl. B08B 9/032; A47J 36/42; G01F 23/00

(52) U.S. Cl. CPC B08B 9/0325; A47J 36/42; G01F 23/0007; B08B 2209/032

(57) ABSTRACT

Embodiments of the present application disclose a seasoning feeding pipeline cleaning apparatus, configured to clean a seasoning feeding pipeline of a cooking device, and including: a cleaning structure, wherein the cleaning structure comprises a water storage box and a first reversing valve, the first reversing valve is provided with at least three interfaces, the at least three interfaces comprises a first interface, a second interface and a third interface, and the first pipeline comprises a first section and a second section; the first interface of the at least three interfaces is connected with the water storage box by a second pipeline, a second interface of the at least three interfaces is connected with the seasoning box by the first section, and a third interface of the at least three interfaces is connected with the seasoning feeding pump by the second section

### CROSS-REFERENCE TO RELATED APPLICATION

The present disclosure is a national stage application of international Patent Application No. PCT/CN2024/097379, which is filed on Jun. 4, 2024, and entitled “Seasoning Feeding Apparatus, Seasoning Feeding Pipeline Cleaning Apparatus and Cleaning Control Method Thereof, and Cooking Device”, the contents of which are here by incorporated by reference in its entirety.

### TECHNICAL FIELD

Embodiments of the present application relate to the field of cooking devices, and in particular to a seasoning feeding apparatus, a seasoning feeding pipeline cleaning apparatus and a cleaning control method thereof, and a cooking device.

### BACKGROUND

Stir-frying is a relatively complex way for cooking food, therefore an automatic stir-frying machine, as an emerging highly intelligent cooking device, has a broad application prospect in various large and small occasions such as restaurants, canteens and households.

During a stir-frying process, adding seasonings is an indispensable step. Seasonings to be added by the automatic stir-frying machine are usually divided into three forms: solid (dry seasonings), liquid (water seasonings) and viscous (sauces), and the seasonings in each form need to be fed by corresponding feeding apparatuses thereof. However, after the liquid or viscous seasonings are fed, solid ingredients contained in the residual seasonings are prone to precipitating in a seasoning feeding pipeline and are prone to caking after being dried, such that the pipeline is prone to being blocked after a long time.

### SUMMARY

Embodiments of the present application provide a seasoning feeding apparatus, and a seasoning feeding pipeline cleaning apparatus and a cleaning control method thereof, so as to effectively prevent the problems of caking and pipeline blockage caused by the precipitation, in a seasoning feeding pipeline, of solid ingredients contained in residual seasonings.

In a first aspect, an embodiment of the present application provides a seasoning feeding pipeline cleaning apparatus, configured to clean a seasoning feeding pipeline of a cooking device, and the seasoning feeding pipeline including a seasoning box, a seasoning feeding pump and a seasoning feeding nozzle, which are sequentially connected by a first pipeline, wherein the seasoning feeding pipeline cleaning apparatus includes:
a cleaning structure, wherein the cleaning structure includes a water storage box and a first reversing valve, the first reversing valve is provided with at least three interfaces, the at least three interfaces includes a first interface, a second interface and a third interface, and the first pipeline includes a first section, and a second section; the first interface of the at least three interfaces is connected with the water storage box by a second pipeline, the second interface of the at least three interfaces is connected with the seasoning box by the first section, and the third interface of the at least three interfaces is connected with the seasoning feeding pump by the second section, so as to form a first cleaning path from the water storage box to the seasoning feeding nozzle, which sequentially passes through the first reversing valve and the seasoning feeding pump, and a second cleaning path from the water storage box to the seasoning box, which sequentially passes through the first reversing valve and the seasoning feeding pump and returns to the first reversing valve.

In some possible implementations, the cleaning structure further provided with a water suction pump and a water spray head, the water suction pump is connected with the water storage box by a third pipeline, and the water spray head is connected with the water suction pump by a fourth pipeline.

In some possible implementations, the cleaning structure further includes a second reversing valve, at least one interface of the second reversing valve is connected to the first reversing valve by a fifth pipeline, and another interface of the second reversing valve is connected to a water inlet by a sixth pipeline, so as to form a third cleaning path from the water inlet to the first reversing valve.

In some possible implementations, the cleaning structure includes: a first one-way valve, which is further disposed between the water storage box and the first reversing valve; and, a second one-way valve, which is further disposed between the water suction pump and the second reversing valve; and, a third one-way valve, which is further disposed between the first reversing valve and the second reversing valve.

In some possible implementations, the cleaning structure includes: a three-way valve, which communicates with the second reversing valve by a sixth pipeline, and communicates with the water storage box by a seventh pipeline, is further disposed at the water inlet; and, the water spray head is connected with the water suction pump by the second reversing valve.

In some possible implementations, the first reversing valve and the second reversing valve are two-position three-way solenoid valves.

In some possible implementations, the water spray head directly communicates with the water inlet by a water inlet pipeline which is provided with a first normally closed switch valve; and, the water storage box directly communicates with the water inlet by a water inlet pipeline which is provided with a second normally closed switch valve.

In some possible implementations, the first normally closed switch valve and the second normally closed switch valve are solenoid valves.

In a second aspect, an embodiment of the present application provides a seasoning feeding apparatus, including:
a seasoning feeding pipeline, including a seasoning box, a seasoning feeding pump and a seasoning feeding nozzle, which are sequentially connected by the first pipeline; and
the seasoning feeding pipeline cleaning apparatus as described above.

In one embodiment, the cleaning structure includes a water suction pump and a water spray head, the water suction pump is connected with the water storage box by a third pipeline, and the water spray head is connected with the water suction pump by a fourth pipeline; a second reversing valve, at least one interface of the second reversing valve is connected to the first reversing valve by a fifth pipeline, and another interface of the second reversing valve is connected to a water inlet by a sixth pipeline, so as to form a third cleaning path from the water inlet to the first reversing valve.

In one embodiment, the cleaning structure includes a first one-way valve, wherein the first one-way valve is further disposed between the water storage box and the first reversing valve, and disposed on the second pipeline; and a second one-way valve, wherein the second one-way valve is further disposed between the water suction pump and the second reversing valve, and disposed on the fourth pipeline; and a third one-way valve, wherein the third one-way valve is further disposed between the first reversing valve and the second reversing valve, and disposed on the fifth pipeline.

In a third aspect, an embodiment of the present application provides a cooking device, including the seasoning feeding apparatus as described above.

In a fourth aspect, an embodiment of the present application provides a seasoning feeding pipeline cleaning control method, used for the above seasoning feeding pipeline cleaning apparatus, and including the following steps:
switching the first reversing valve to open the first cleaning path, starting the seasoning feeding pump in a forward direction, and pumping out water in the water storage box from the first cleaning path, so as to complete a cleaning operation on a segment from the first reversing valve to the seasoning feeding nozzle; and
switching the first reversing valve to open the second cleaning path, starting the seasoning feeding pump in a reverse direction, and pumping out the water in the water storage box from the second cleaning path, so as to complete a cleaning operation on a segment from the seasoning feeding pump to the seasoning box;

In a fifth aspect, an embodiment of the present application provides a seasoning feeding pipeline cleaning control method, used for the above seasoning feeding pipeline cleaning apparatus, and including the following steps:
opening the water inlet and the third one-way valve, switching the second reversing valve to open the third cleaning path, switching the first reversing valve to open the first cleaning path, closing the first one-way valve, and starting the seasoning feeding pump in the forward direction, so as to complete the cleaning operation on the segment from the first reversing valve to the seasoning feeding nozzle; and
opening the water inlet and the third one-way valve, switching the second reversing valve to open the third cleaning path, switching the first reversing valve to open the second cleaning path, closing the first one-way valve, and starting the seasoning feeding pump in the reverse direction, so as to complete the cleaning operation on the segment from the seasoning feeding pump to the seasoning box.

In some possible implementations, the method further includes the following steps:
starting the water suction pump, opening the second one-way valve, and pumping the water in the water storage box into the water spray head to inject the water into a pot, so as to complete a water adding or pot washing operation.

In some possible implementations, the method further includes the following steps:
before the first cleaning path/the second cleaning path is opened, the method further includes the following steps:
detecting whether the amount of water stored in the water storage box reaches a preset amount of water, and if not, opening the water inlet to inject water into the water storage box until reaching the preset amount of water.

In one embodiment, the cleaning structure includes: a water suction pump and a water spray head, the water suction pump is connected with the water storage box by a third pipeline, and the water spray head is connected with the water suction pump by a fourth pipeline; a second reversing valve, at least one interface of the second reversing valve is connected to the first reversing valve by a fifth pipeline, and another interface of the second reversing valve is connected to a water inlet by a sixth pipeline, so as to form a third cleaning path from the water inlet to the first reversing valve; a first one-way valve, the first one-way valve is further disposed between the water storage box and the first reversing valve, and disposed on the second pipeline; and a second one-way valve, the second one-way valve is further disposed between the water suction pump and the second reversing valve, and disposed on the fourth pipeline; and a third one-way valve, the third one-way valve is further disposed between the first reversing valve and the second reversing valve, and disposed on the fifth pipeline.

In one embodiment, the cleaning structure includes a first one-way valve, the first one-way valve is further disposed between the water storage box and the first reversing valve, and disposed on the second pipeline; or, a second one-way valve, the second one-way valve is further disposed between the water suction pump and the second reversing valve, and disposed on the fourth pipeline; or, a third one-way valve, the third one-way valve is further disposed between the first reversing valve and the second reversing valve, and disposed on the fifth pipeline.

In one embodiment, the cleaning structure comprises: a three-way valve, which communicates with the second reversing valve and the water storage box by fifth pipelines, is further disposed at the water inlet; or, the water spray head is connected with the water suction pump by the second reversing valve.

In one embodiment, the water spray head directly communicates with the water inlet by a water inlet pipeline which is provided with a first normally closed switch valve; or the water storage box directly communicates with the water inlet by a water inlet pipeline which is provided with a second normally closed switch valve.

The present application has the beneficial effects as follows:

In the embodiments of the present application, the cleaning path having the water storage box and the first reversing valve is provided, and the first reversing valve is disposed between the seasoning box and the seasoning feeding pump to form the first cleaning path from the water storage box to the seasoning feeding nozzle, which passes through the first reversing valve and the seasoning feeding pump, and the second cleaning path from the water storage box to the seasoning box, which passes through the first reversing valve and the seasoning feeding pump and returns to the first reversing valve, therefore segmented cleaning of the seasoning feeding pipeline is implemented by the first cleaning path and the second cleaning path, thereby effectively preventing the problems of caking and pipeline blockage caused by the precipitation, in the seasoning feeding pipeline, of solid ingredients contained in residual seasonings.

### BRIEF DESCRIPTION OF THE DRAWINGS

To illustrate technical solutions in the embodiments of the present application or in the prior art more clearly, a brief introduction on the drawings which are needed in the description of the embodiments or the prior art is given below. Apparently, the drawings in the description below are merely some of the embodiments of the present application, based on which other drawings may be obtained by those ordinary skilled in the art without any creative effort.

FIG. 1 illustrates a schematic structural diagram of a seasoning dispensing apparatus according to one embodiment of the present application.

FIG. 2 illustrates a schematic structural diagram of a seasoning dispensing apparatus according to another embodiment of the present application.

### DESCRIPTION OF REFERENCE SIGNS

1—seasoning feeding pipeline, 10—seasoning feeding port, 11—seasoning box, 12—seasoning feeding pump, 13—seasoning feeding nozzle;
2—seasoning feeding pipeline cleaning apparatus, 20—water inlet, 21—water storage box, 22—first reversing valve, 23—water suction pump, 24—water spray head, 25—second reversing valve, 26—first one-way valve, 27—second one-way valve, 28—third one-way valve, 29—three-way valve; and
31—first cleaning path, 32—second cleaning path, 33—third cleaning path.

### DETAILED DESCRIPTION OF THE EMBODIMENTS

In order to make the objectives, technical solutions and advantages of the present application more clearer, the technical solutions of the present application will be described in detail below by implementations, with reference to the drawings in the embodiments of the present application. Obviously, in the case of no conflict, the embodiments in the present application and features in the embodiments may be combined with each other.

It should be noted that throughout the drawings, the same or similar reference signs refer to the same or similar elements or elements with the same or similar functions; in the description of the present application, orientation or position relationships indicated by terms “center”, “longitudinal”, “transverse”, “front”, “rear”, “left”, “right”, “vertical”, “horizontal”, “top”, “bottom”, “inside”, “outside” and the like are orientation or position relationships shown on the basis of the drawings, and are merely for the convenience of describing the present application and simplifying the description, but do not indicate or imply that the referred apparatuses or elements must have specific orientations or must be constructed and operated in specific orientations, and thus cannot be construed as limitations to the protection scope of the present application; and in the description of the present application, “first”, “second” and the like are merely intended to distinguish from each other, and are not intended to indicate the importance or sequence thereof.

In the description of the present application, unless otherwise expressly specified and limited, the terms “installed”, “connected” and “connection” should be understood in a broad sense. For example, the connection may be a fixed connection, or a movable connection, and may also be a detachable connection; may be a mechanical connection, and may also be an electrical connection; and may be a direct connection, may be an indirect connection through an intermediate medium, and may also be internal communication between two elements. For those ordinary skilled in the art, the specific meanings of the above terms in the present application may be understood in specific situations.

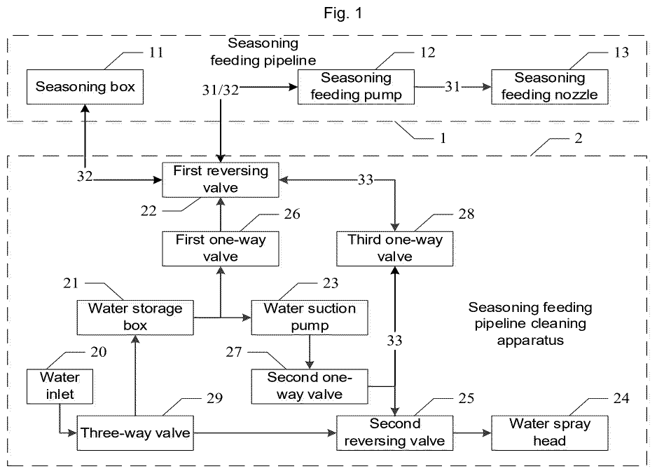

Referring to FIG. 1, an embodiment of the present application provides a seasoning feeding pipeline cleaning apparatus 2, configured to clean a seasoning feeding pipeline 1 of a cooking device, and the seasoning feeding pipeline 1 including a seasoning box 11, a seasoning feeding pump 12 and a seasoning feeding nozzle 13, which are sequentially connected by a first pipeline, wherein the seasoning feeding pipeline cleaning apparatus 2 includes:

a cleaning structure, wherein the cleaning structure includes a water storage box 21 and a first reversing valve 22, the first reversing valve 22 is provided with at least three interfaces, the at least three interfaces comprises a first interface, a second interface and a third interface, and the first pipeline comprises a first section and a second section; the first interface of the at least three interfaces is connected with the water storage box by a second pipeline, a second interface of the at least three interfaces is connected with the seasoning box by the first section, and a third interface of the at least three interfaces is connected with the seasoning feeding pump by the second section, so as to form a first cleaning path 31 from the water storage box 21 to the seasoning feeding nozzle 13, which sequentially passes through the first reversing valve 22 and the seasoning feeding pump 12, and a second cleaning path 32 from the water storage box 21 to the seasoning box 11, which sequentially passes through the first reversing valve 22 and the seasoning feeding pump 12 and returns to the first reversing valve 22.

In some possible implementations, the cleaning structure 3 is further includes a water suction pump 23 and a water spray head 24, the water suction pump 23 is connected with the water storage box 21 by a third pipeline, and the water spray head 24 is connected with the water suction pump 23 by a fourth pipeline.

In some possible implementations, the cleaning structure 3 is further includes a second reversing valve 25, at least one interface of the second reversing valve 25 is connected to the first reversing valve 22 by a fifth pipeline, and another interface of the second reversing valve is connected to a water inlet 20 by a sixth pipeline, so as to form a third cleaning path 33 from the water inlet 20 to the first reversing valve 22.

The first reversing valve 22 plays a role in selecting the opening of the first cleaning path 31 or the second cleaning path 32: if the third interface of the at least three interfaces connected with the seasoning feeding pump 12 of the first reversing valve 22 is opened, and the second interface of the at least three interfaces connected with the seasoning box 11 of the first reversing valve 22is closed, the first cleaning path 31 is opened, and the second cleaning path 32 is closed; and otherwise, the first cleaning path 31 is closed, and the second cleaning path 32 is opened.

In some possible implementations, a first one-way valve 26 is further disposed between the water storage box 21 and the first reversing valve 22, and disposed on the second pipeline.

In some possible implementations, a second one-way valve 27 is further disposed between the water suction pump 23 and the second reversing valve 25, and disposed on the fourth pipeline.

In some possible implementations, a third one-way valve 28 is further disposed between the first reversing valve 22 and the second reversing valve 25, and disposed on the fifth pipeline.

In some possible implementations, a first one-way valve 26 is further disposed between the water storage box 21 and the first reversing valve 22, and disposed on the second pipeline; and a second one-way valve 27 is further disposed between the water suction pump 23 and the second reversing valve 25, and disposed on the fourth pipeline; and a third one-way valve 28 is further disposed between the first reversing valve 22 and the second reversing valve 25, and disposed on the fifth pipeline.

By opening the first one-way valve 26, the first cleaning path 31 or the second cleaning path 32 acquires a water source from the water storage box 21; and by closing the first one-way valve 26, the third one-way valve 28 is opened, so that the first cleaning path 31 or the second cleaning path 32 acquires the water source from the water inlet 20.

By opening the second one-way valve 27, the water spray head 24 acquires the water source from the water storage box 21; and by closing the second one-way valve 27, the water spray head 24 acquires the water source from the water inlet 20.

By opening the third one-way valve 28, the third cleaning path 33 is opened, and the first cleaning path 31 or the second cleaning path 32 acquires the water source from the water inlet 20; and by closing the third one-way valve 28, the first one-way valve 26 is opened, so that the first cleaning path 31 or the second cleaning path 32 acquires the water source from the water storage box 21.

In some possible implementations, a three-way valve 29, which communicates with the second reversing valve 25 by a sixth pipeline, and communicates with the water storage box 21 by a seventh pipeline, is further disposed at the water inlet 20.

In some possible implementations, the water spray head 24 is connected with the water suction pump 23 by the second reversing valve 25.

In some possible implementations a three-way valve 29, which communicates with the second reversing valve 25 by a sixth pipeline, and communicates with the water storage box 21 by a seventh pipeline, is further disposed at the water inlet 20; and the water spray head 24 is connected with the water suction pump 23 by the second reversing valve 25.

The second reversing valve 25 is not only play a role in selecting to acquire the water source from the water storage box 21 or the water inlet 20 to the water spray head 24, but also play the role in acquiring the water source from the water inlet 20 to the third cleaning path 33 or the water spray head 24, as long as a corresponding interface is controlled to be opened and the other interfaces are closed specifically, and thus details are not repeated described herein again.

In some possible implementations, the first reversing valve 22 and the second reversing valve 25 are two-position three-way solenoid valves. The three-way valve 29 is a normally closed solenoid valve.

In some possible implementations, the first reversing valve 22 or the second reversing valve 25 is two-position three-way solenoid valves.

In some possible implementations, the seasoning feeding pipeline cleaning apparatus is further include an MCU control unit, configured to control the automatic switching of the first cleaning path 31 and the second cleaning path 32. Further, the MCU is also control the automatic switching of various control valves such as the third cleaning path 33, the first one-way valve 26, the second one-way valve 27, the third one-way valve 28, or the three-way valve 29.

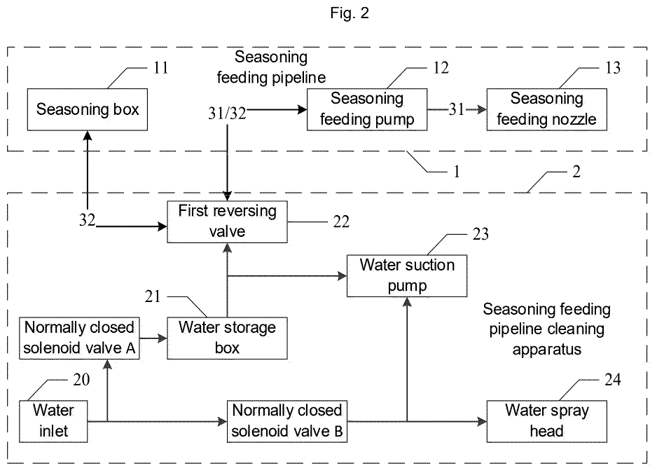

Referring to FIG. 2, the present application further provides another embodiment of the seasoning feeding pipeline cleaning apparatus 2. The difference between the embodiment of the present application and the foregoing embodiment lies in that:

In some possible implementations, the water spray head 24 directly communicates with the water inlet 20 by a water inlet pipeline which is provided with a first normally closed switch valve B. In some possible implementations, the water storage box 21 directly communicates with the water inlet 20 by a water inlet pipeline which is provided with a second normally closed switch valve A.

In some possible implementations, the water spray head 24 directly communicates with the water inlet 20 by a water inlet pipeline which is provided with a first normally closed switch valve B; and the water storage box 21 directly communicates with the water inlet 20 by a water inlet pipeline which is provided with a second normally closed switch valve A.

Referring to FIG. 1 and FIG. 2, an embodiment of the present application further provides a seasoning feeding apparatus, including:

a seasoning feeding pipeline 1, including a seasoning box 11, a seasoning feeding pump 12 and a seasoning feeding nozzle 13, which are sequentially connected by the first pipeline; and the seasoning feeding pipeline cleaning apparatus 2 provided in any implementation of the foregoing embodiments.

Correspondingly, the technical effects thereof are also completely applicable to the present embodiment, and thus details are not described herein again.

An embodiment of the present application further provides a seasoning feeding pipeline cleaning control method, used for the seasoning feeding pipeline cleaning apparatus provided in any implementation in the foregoing embodiments, and including the following steps:
switching the first reversing valve 22 to open the first cleaning path 31, starting the seasoning feeding pump 12 in a forward direction, and pumping out water in the water storage box 21 from the first cleaning path 31, so as to complete a cleaning operation on a segment from the first reversing valve 22 to the seasoning feeding nozzle 13; and
switching the first reversing valve 22 to open the second cleaning path 32, starting the seasoning feeding pump 12 in a reverse direction, and pumping out the water in the water storage box 21 from the second cleaning path 32, so as to complete a cleaning operation on a segment from the seasoning feeding pump 12 to the seasoning box 11.

An embodiment of the present application further provides a seasoning feeding pipeline cleaning control method, used for the seasoning feeding pipeline cleaning apparatus provided in any implementation in the foregoing embodiments, and including the following steps:
opening the water inlet 20 and the third one-way valve 28, switching the second reversing valve 25 to open the third cleaning path 33, switching the first reversing valve 22 to open the first cleaning path 31, closing the first one-way valve 26, and starting the seasoning feeding pump 12 in the forward direction, so as to complete the cleaning operation on the segment from the first reversing valve 22 to the seasoning feeding nozzle 13; and
opening the water inlet 20 and the third one-way valve 28, switching the second reversing valve 25 to open the third cleaning path 33, switching the first reversing valve 22 to open the second cleaning path 32, closing the first one-way valve 26, and starting the seasoning feeding pump 12 in the reverse direction, so as to complete the cleaning operation on the segment from the seasoning feeding pump 12 to the seasoning box 11.

In some possible implementations, the method further includes the following steps:
starting the water suction pump 23, opening the second one-way valve 27, and pumping the water in the water storage box 21 into the water spray head 24 to inject the water into a pot (which is placed below the water spray head 24), so as to complete a water adding or pot washing operation.

The water in the water storage box 21 is pumped by the water suction pump 23 according to a required dosage and is accurately fed into the pot from the water spray head 24 without being impacted by a water pressure change in a tap water pipeline, thereby achieving the effect of pressure-stabilization feeding.

In some possible implementations, before the first cleaning path 31 or the second cleaning path 32 is opened, the method further includes the following steps:
detecting whether the amount of water stored in the water storage box 21 reaches a preset amount of water, and if not, opening the water inlet 20 to inject water into the water storage box 21 until reaching the preset amount of water. The preset amount of water is the maximum amount of water stored in the water storage box 21, or is specifically set as required.

Correspondingly, the technical effects thereof are also completely applicable to the present embodiment, and thus details are not described herein again.

An embodiment of the present application further provides a cooking device, including the seasoning feeding apparatus provided in any implementations in the foregoing embodiments. Correspondingly, the technical effects thereof are also completely applicable to the present embodiment, and thus details are not described herein again.

In some possible implementations, the cooking device is an automatic stir-frying machine.

It should be noted that the above descriptions are only preferred embodiments of the present application and used technical principles. Those skilled in the art will understand that the present application is not limited to the specific embodiments described herein, and various obvious changes, readjustments and substitutions may be made by those skilled in the art without departing from the protection scope of the present application. Therefore, although the present application has been described in detail by the above embodiments, the present application is not merely limited to the above embodiments, but may further include more other equivalent embodiments without departing from the concept of the present application, and the scope of the present application is determined by the appended claims.

1. A seasoning feeding pipeline cleaning apparatus, configured to clean a seasoning feeding pipeline of a cooking device, and the seasoning feeding pipeline comprising a seasoning box, a seasoning feeding pump and a seasoning feeding nozzle, which are sequentially connected by a first pipeline, wherein the seasoning feeding pipeline cleaning apparatus comprises:
a cleaning structure, wherein the cleaning structure comprises a water storage box and a first reversing valve, the first reversing valve is provided with at least three interfaces, the at least three interfaces comprises a first interface, a second interface and a third interface, and the first pipeline comprises a first section and a second section;
the first interface of the at least three interfaces is connected with the water storage box by a second pipeline, a second interface of the at least three interfaces is connected with the seasoning box by the first section, and a third interface of the at least three interfaces is connected with the seasoning feeding pump by the second section, so as to form a first cleaning path from the water storage box to the seasoning feeding nozzle, which sequentially passes through the first reversing valve and the seasoning feeding pump, and a second cleaning path from the water storage box to the seasoning box, which sequentially passes through the first reversing valve and the seasoning feeding pump and returns to the first reversing valve.

2. The seasoning feeding pipeline cleaning apparatus as claimed in claim 1, wherein:
the cleaning structure further comprises a water suction pump and a water spray head, the water suction pump is connected with the water storage box by a third pipeline, and the water spray head is connected with the water suction pump by a fourth pipeline.

3. The seasoning feeding pipeline cleaning apparatus as claimed in claim 1, wherein:
the cleaning structure further comprises a second reversing valve, at least one interface of the second reversing valve is connected to the first reversing valve by a fifth pipeline, and another interface of the second reversing valve is connected to a water inlet by a sixth pipeline, so as to form a third cleaning path from the water inlet to the first reversing valve.

4. The seasoning feeding pipeline cleaning apparatus as claimed in claim 3, wherein the cleaning structure comprises:
a first one-way valve, wherein the first one-way valve is further disposed between the water storage box and the first reversing valve, and disposed on the second pipeline; and
a second one-way valve, wherein the second one-way valve is further disposed between the water suction pump and the second reversing valve, and disposed on the fourth pipeline; and
a third one-way valve, wherein the third one-way valve is further disposed between the first reversing valve and the second reversing valve, and disposed on the fifth pipeline.

5. The seasoning feeding pipeline cleaning apparatus as claimed in claim 4, wherein the cleaning structure comprises:
a three-way valve, which communicates with the second reversing valve by the sixth pipeline, and communicates with the water storage box by a seventh pipeline, is further disposed at the water inlet; and, the water spray head is connected with the water suction pump by the second reversing valve.

6. The seasoning feeding pipeline cleaning apparatus as claimed in claim 5, wherein the first reversing valve and the second reversing valve are two-position three-way solenoid valves.

7. The seasoning feeding pipeline cleaning apparatus as claimed in claim 2, wherein:
the water spray head directly communicates with the water inlet by a water inlet pipeline which is provided with a first normally closed switch valve; and, the water storage box directly communicates with the water inlet by a water inlet pipeline which is provided with a second normally closed switch valve.

8. The seasoning feeding pipeline cleaning apparatus as claimed in claim 7, wherein the first normally closed switch valve and the second normally closed switch valve are solenoid valves.

9. A seasoning feeding apparatus, comprising:
a seasoning feeding pipeline, comprising a seasoning box, a seasoning feeding pump and a seasoning feeding nozzle, which are sequentially connected by the first pipeline; and
the seasoning feeding pipeline cleaning apparatus as claimed in claim 1 .

10. A cooking device, comprising the seasoning feeding apparatus as claimed in claim 9.

11. A seasoning feeding pipeline cleaning control method, used for the seasoning feeding pipeline cleaning apparatus as claimed in claim 1, and comprising the following steps:
switching the first reversing valve to open the first cleaning path, starting the seasoning feeding pump in a forward direction, and pumping out water in the water storage box from the first cleaning path, so as to complete a cleaning operation on a segment from the first reversing valve to the seasoning feeding nozzle; and
switching the first reversing valve to open the second cleaning path, starting the seasoning feeding pump in a reverse direction, and pumping out the water in the water storage box from the second cleaning path, so as to complete a cleaning operation on a segment from the seasoning feeding pump to the seasoning box.

12. A seasoning feeding pipeline cleaning control method, used for the seasoning feeding pipeline cleaning apparatus as claimed in claim 4, and comprising the following steps:
opening the water inlet and the third one-way valve, switching the second reversing valve to open the third cleaning path, switching the first reversing valve to open the first cleaning path, closing the first one-way valve, and starting the seasoning feeding pump in the forward direction, so as to complete the cleaning operation on the segment from the first reversing valve to the seasoning feeding nozzle; and
opening the water inlet and the third one-way valve, switching the second reversing valve to open the third cleaning path, switching the first reversing valve to open the second cleaning path, closing the first one-way valve, and starting the seasoning feeding pump in the reverse direction, so as to complete the cleaning operation on the segment from the seasoning feeding pump to the seasoning box.

13. The seasoning feeding apparatus as claimed in claim 9, wherein the cleaning structure comprises:
a water suction pump and a water spray head, the water suction pump is connected with the water storage box by a third pipeline, and the water spray head is connected with the water suction pump by a fourth pipeline;
a second reversing valve, at least one interface of the second reversing valve is connected to the first reversing valve by a fifth pipeline, and another interface of the second reversing valve is connected to a water inlet by a sixth pipeline, so as to form a third cleaning path from the water inlet to the first reversing valve.

14. The seasoning feeding apparatus as claimed in claim 10, wherein the cleaning structure comprises:
a first one-way valve, wherein the first one-way valve is further disposed between the water storage box and the first reversing valve, and disposed on the second pipeline; and
a second one-way valve, wherein the second one-way valve is further disposed between the water suction pump and the second reversing valve, and disposed on the fourth pipeline; and
a third one-way valve, wherein the third one-way valve is further disposed between the first reversing valve and the second reversing valve, and disposed on the fifth pipeline.

15. The seasoning feeding pipeline cleaning control method as claimed in claim 14, the seasoning feeding pipeline cleaning control method further comprising the following steps:
starting the water suction pump, opening the second one-way valve, and pumping the water in the water storage box into the water spray head to inject the water into a pot, so as to complete a water adding or pot washing operation.

16. The seasoning feeding pipeline cleaning control method as claimed in claim 14, before the first cleaning path or the second cleaning path is opened, the method further comprises the following steps:
detecting whether the amount of water stored in the water storage box reaches a preset amount of water, and if not, opening the water inlet to inject water into the water storage box until reaching the preset amount of water.

17. The seasoning feeding pipeline cleaning control method as claimed in claim 13, wherein the cleaning structure comprises:
a water suction pump and a water spray head, the water suction pump is connected with the water storage box by a third pipeline, and the water spray head is connected with the water suction pump by a fourth pipeline;
a second reversing valve, at least one interface of the second reversing valve is connected to the first reversing valve by a fifth pipeline, and another interface of the second reversing valve is connected to a water inlet by a sixth pipeline, so as to form a third cleaning path from the water inlet to the first reversing valve;
a first one-way valve, wherein the first one-way valve is further disposed between the water storage box and the first reversing valve, and disposed on the second pipeline; and
a second one-way valve, wherein the second one-way valve is further disposed between the water suction pump and the second reversing valve, and disposed on the fourth pipeline; and
a third one-way valve, wherein the third one-way valve is further disposed between the first reversing valve and the second reversing valve, and disposed on the fifth pipeline.

18. The seasoning feeding pipeline cleaning apparatus as claimed in claim 3, wherein the cleaning structure comprises:
a first one-way valve, wherein the first one-way valve is further disposed between the water storage box and the first reversing valve, and disposed on the second pipeline; or,
a second one-way valve, wherein the second one-way valve is further disposed between the water suction pump and the second reversing valve, and disposed on the fourth pipeline; or,
a third one-way valve, wherein the third one-way valve is further disposed between the first reversing valve and the second reversing valve, and disposed on the fifth pipeline.

19. The seasoning feeding pipeline cleaning apparatus as claimed in claim 4, wherein the cleaning structure comprises:
a three-way valve, which communicates with the second reversing valve and the water storage box by fifth pipelines, is further disposed at the water inlet; or, the water spray head is connected with the water suction pump by the second reversing valve.

20. The seasoning feeding pipeline cleaning apparatus as claimed in claim 2, wherein:
the water spray head directly communicates with the water inlet by a water inlet pipeline which is provided with a first normally closed switch valve; or
the water storage box directly communicates with the water inlet by a water inlet pipeline which is provided with a second normally closed switch valve.
